(19) United States
(12) Patent Application Publication
(10) Pub. No.: US 2010/0178138 A1
(43) Pub. Date: Jul. 15, 2010

(54) APPARATUS AND METHOD FOR LOADING CARTRIDGE HOLDING REACTANT INTO REACTANT CHAMBER OF REACTOR

(75) Inventors: Do-gyoon Kim, Yongin-si (KR); Kwang-il Kim, Suwon-si (KR); Jong-myeon Park, Seoul (KR); Hyun-min Kim, Gwangju-si (KR); Ho-jin Kim, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/543,114

(22) Filed: Aug. 18, 2009

(30) Foreign Application Priority Data
Jan. 12, 2009 (KR) 10-2009-0002384

(51) Int. Cl. B65G 37/00

(52) U.S. Cl. 414/222.08; 414/806

(57) ABSTRACT

An apparatus for loading cartridges holding reactants into reactant chambers of a reactor is provided. The apparatus includes: at least one guide rail which transfers a cartridge; an extraction unit comprising at least one storage portion and a blocking portion, the extraction unit moving between a first position in which the blocking portion blocks an outlet of the guide rail and a second position in which the cartridge is output through the outlet of the guide rail and stored by the storage portion; a transfer unit which moves the reactor so that a chamber of the reactor is aligned with the storage portion; and an insertion unit which moves the cartridge from the storage portion into the chamber of the reactor.

### CROSS-REFERENCE TO RELATED APPLICATION

This application claims the benefit of Korean Patent Application No. 10-2009-0002384, filed on Jan. 12, 2009, in the Korean Intellectual Property Office, the disclosure of which is incorporated herein in its entirety by reference.

### BACKGROUND

1. Field

Embodiments relate to an apparatus and method for loading a cartridge holding reactant into a reactant chamber of a reactor.

2. Description of the Related Art

Various methods of analyzing a sample have been developed to, for example, monitor environments, examine food, or diagnose the medical condition of a patient. However, these methods require many manual operations and various devices. To perform an examination according to a predetermined protocol, those skilled in the manual operations repeatedly perform various processes including loading a reagent, mixing, isolating and transporting, reacting, and centrifuging. Such manually operated, repeated processes, however, often cause erroneous results due to “human errors.”

To perform examinations quickly, skilled clinical pathologists are needed. However, it may be difficult for even a skilled clinical pathologist to perform various examinations simultaneously. Also, rapid examination results are essential for immediate timely treatments of emergency patients. Accordingly, there is a need to develop various types of equipment enabling simultaneous, rapid and accurate pathological examinations for given circumstances.

As an example, a blood sample is loaded into a disc-shaped microfluidic device and the disc-shaped microfluidic device is rotated to isolate serum from the blood sample due to the centrifugal force. The isolated serum is mixed with a predetermined amount of a diluent and the resulting mixture then flows to one or more reaction chambers (in the disc-shaped microfluidic device. The reaction chambers are filled with a reagent prior to allowing the mixture to flow therein. The reagent used may differ according to the goal of the test. When serum is mixed with different reagents, the mixture of the serum and the reagent may change color. The change in color is used to perform a quantitative and qualitative analysis of a blood sample.

### SUMMARY

One or more embodiments include an apparatus for loading a reactant into a reactant chamber of a reactor, in which a chemical or a biochemical reaction takes place, and a method of loading reactants.

Additional aspects will be set forth in part in the detailed description which follows and, in part, will be apparent from the detailed description, or may be learned by practice of the invention.

According to an aspect of one or more embodiments, there is provided an apparatus for loading cartridges holding reactants into reactant chambers of a reactor, the apparatus including: at least one guide rail which is inclined in a downward direction so as to transfer the cartridges along the inside of the guide rail; an extraction unit having at least one storage portion storing the cartridges supplied along the guide rail, a blocking portion blocking an outlet of the guide rail, the extraction unit moving between a first position to block the outlet of the guide rail and a second position to store the cartridges; a transfer unit for loading the reactor thereon, the transfer unit slid and rotated so that the reactant chambers face the storage portion; and an insertion unit pushing the cartridges stored in the storage portion and thereby inserting the cartridges into the reactant chambers of the reactor facing the storage portion.

The guide rail may include at least one curved section so that an outlet of the guide rail faces a vertically fall direction. The storage portion may be disposed below the outlet of the guide rail in the second position. The transfer unit may move the reactant chambers of the reactor to be disposed below the storage portion.

The storage portion may include an upper part, a lower part, and one side that are opened. The apparatus may further include a fall-prevention unit preventing the cartridges stored in the storage portion from falling. The fall-prevention unit may include a negative pressure providing unit providing negative pressure to the storage portion.

The reactant may be a solid-state reactant. The reactant may be a lyophilized reactant.

The apparatus may further include a tray having at least one tunnel shaped rail of which end parts in a longitudinal direction are opened so that the cartridges are capable of being installed therein; a holder on which the tray is mounted; and an arrangement unit, on which the holder is installed, arranging the end parts of the tray and the guide rail in a row so that the cartridges can be moved to the guide rail from the tray. The arrangement unit may be rotated from an installation position, where the holder is installed, to an inclined position, being inclined similarly to the guide rail. The apparatus may further include a maintaining unit maintaining the arrangement unit at the inclined position. The maintaining unit maintains the arrangement unit at the inclined position by using a magnetic force.

According to another aspect of one or more embodiments, there is provided a method of loading reactants, the method including: supplying cartridges holding reactants to the inside of a guide rail that is inclined in a downward direction; moving an extraction unit including a storage portion from a first position blocking an outlet of the guide rail to an second position and thereby storing the cartridges in the storage portion; sliding and/or rotating a transfer unit, on which a reactor is installed, and facing reactant chamber of the reactor toward the storage portion; pushing the cartridge stored in the storage portion by using an insertion unit and inserting the cartridge into the reactant chamber.

The storing of the cartridges in the storage portion may include providing negative pressure for maintaining the cartridges stored in the storage portion, in the storage portion. The supplying of the cartridges to the inside of the guide rail may include: storing the cartridges in a tray having a tunnel form, in which end parts of the tray in a longitudinal direction are opened; and arranging the tray and an inlet of the guide rail in a row. The arranging of the tray and an inlet of the guide rail in a row may include: mounting one tray on a holder; installing the holder in the arrangement unit positioned at an installation position; rotating the arrangement unit so that the trays are inclined similarly to the guide rail and an outlet of the tray face the inlet of the guide rail. The installation position may have an angle in which the cartridges in the tray are not separated from the tray when the cartridges slide due to gravity.

### BRIEF DESCRIPTION OF THE DRAWINGS

These and/or other aspects will become apparent and more readily appreciated from the following description of the embodiments, taken in conjunction with the accompanying drawings in which:

FIG. 1 is a side view schematically illustrating a loading apparatus according to an embodiment;

FIG. 2 is a perspective view of a guide rail illustrated in FIG. 1;

FIG. 3A illustrates an extraction unit illustrated in FIG. 1;

FIG. 3B illustrates the extraction unit positioned in an extraction position;

FIG. 3C illustrates the extraction unit having cartridges stored therein;

FIG. 4 is a perspective view of a transfer unit illustrated in FIG. 1;

FIG. 5 illustrates a cartridge being inserted by an insertion unit into a reaction chamber of a reactor;

FIG. 6 is side view schematically illustrating a loading apparatus according to another embodiment;

FIG. 7 is a side view of the loading apparatus of FIG. 6 in which an arrangement unit is positioned at an inclined position;

FIG. 8 illustrates a tray and a holder illustrated in FIG. 6 in more detail; and

FIGS. 9A and 9B are cross sectional diagrams of microfluidic devices respectively having a double-substrate structure and a triple-substrate structure.

### DETAILED DESCRIPTION

Reference will now be made in detail to embodiments, examples of which are illustrated in the accompanying drawings, wherein like reference numerals refer to the like elements throughout.

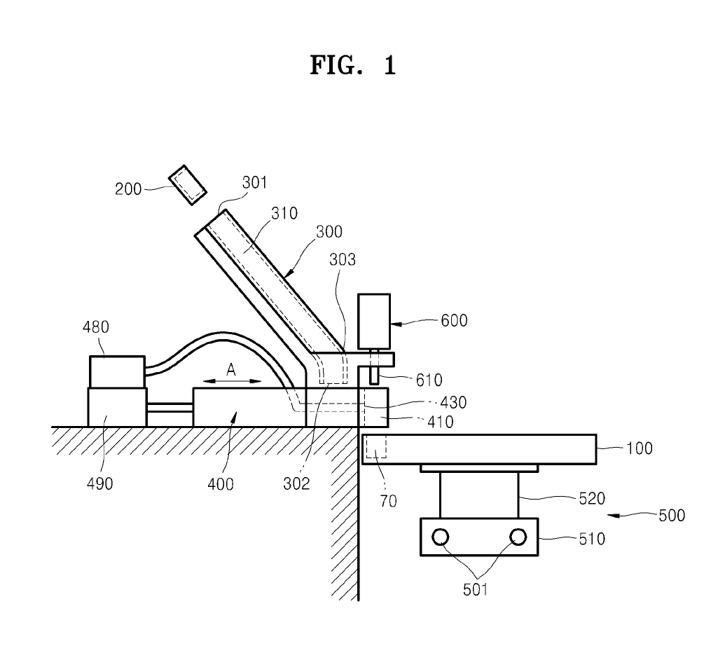

FIG. 1 is a side view schematically illustrating a loading apparatus according to an embodiment. Referring to FIG. 1, the loading apparatus includes a guide rail 300, an extraction unit 400, a transfer unit 500, and an insertion unit 600.

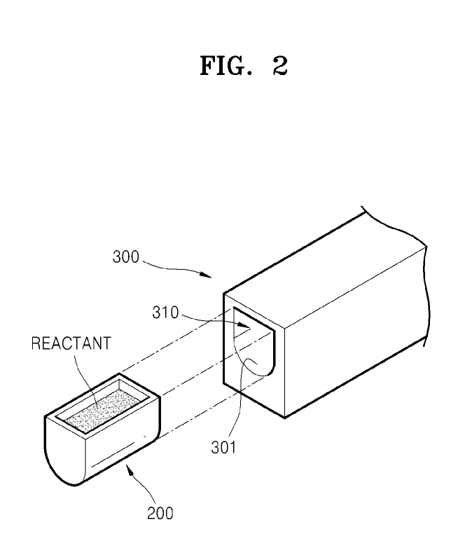

The guide rail 300 includes a rail 310 that allows a cartridge 200 holding a reactant to be transferred through the guide rail 300. In the present embodiment, the cartridge 200 holds a solid-state reactant. The solid-state reactant may be, for example, lyophilized in the cartridge 200. The guide rail 300 is inclined so that the cartridge 200 can be transferred by gravity within the guide rail 300. The guide rail 300 includes an inlet 301 and an outlet 302 which are opened. The cartridge 200 is supplied to the guide rail 300 through the inlet 301 and is supplied to a storage portion 410 through the outlet 302. In FIG. 2, one rail 310 is included in the guide rail 300. However, the present embodiment is not limited thereto and a plurality of guide rails 300 may be arranged in rows. In this case, the cartridges 200 each holding a different reactant may be respectively provided to the guide rail 300. As illustrated in FIG. 1, the guide rail 300 may include a curved section 303 for the outlet 302 to face a vertically fall direction. The curved section 303 has a gentle curvature so that the cartridge 200 can be naturally transferred along the rail 300 by its own weight.

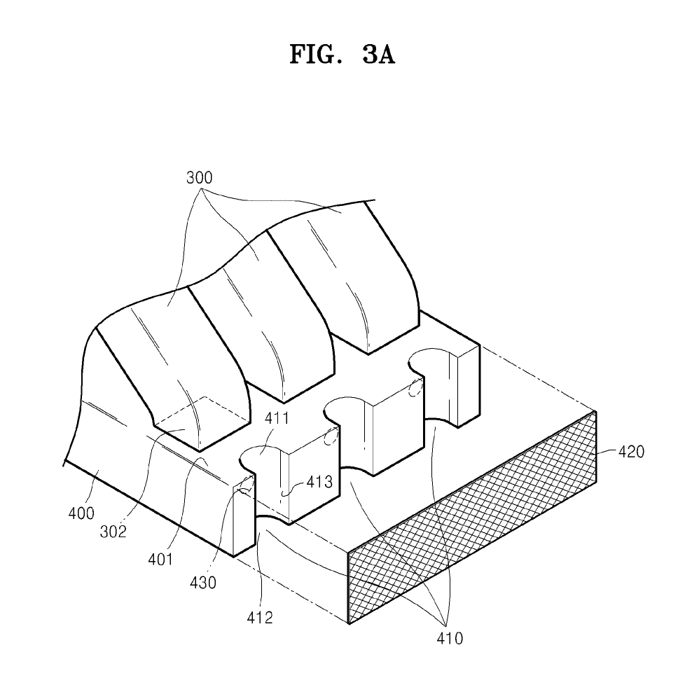

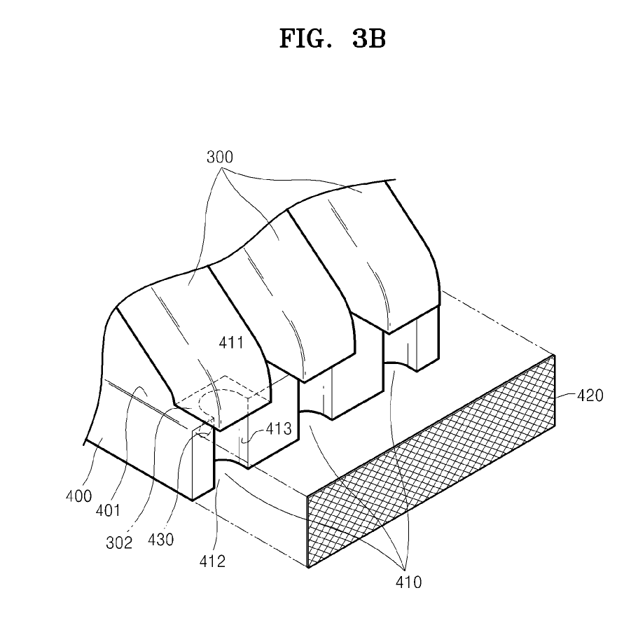

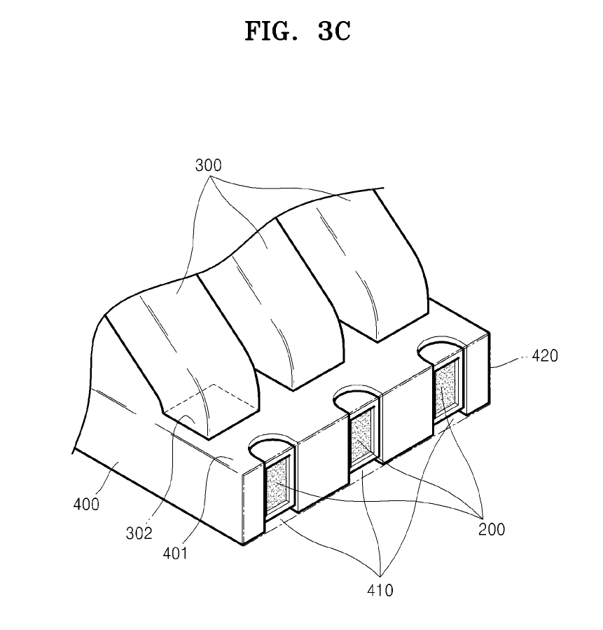

FIG. 3A illustrates the extraction unit 400 illustrated in FIG. 1. Referring to FIG. 3A, the extraction unit 400 includes the storage portions 410 for storing the cartridges 200 one by one as they are discharged through the outlets 302 of the guide rails 300. The extraction unit 400 may include a plurality of storage portions 410 respectively corresponding to the outlets 302 of a plurality of guide rails 300. As an example, the storage portions 410 may have upper parts 411 and lower parts 412 that are opened. Also, the storage portions 410 may have opened side parts 413. In this case, a screen 420 may be disposed on the side parts 413 for preventing the cartridges 200 from being separated from the storage portions 410 through the side parts 413. The screen 420 may also prevent the reactants accommodated in the cartridges 200 from being contaminated by dust while a loading process is being performed.

The extraction unit 400 may be moved by an actuator 490 in an (A) direction shown by an arrow in FIG. 1. The extraction unit 400 in FIG. 3A is positioned in a blocking (first) position so that an upper surface (blocking portion) 401 of the extraction unit 400 blocks the outlets 302 of the guide rails 300 and thus, the cartridges 200 are not extracted from the guide rails 300. The extraction unit 400 in FIG. 3B is in an extraction (second) position so that the storage portions 410 are positioned below the outlets 302 of the guide rails 300. Here, the cartridges 200 fall from the guide rails 300 and are stored in the storage portions 410. In this case, in order to prevent the cartridges 200 from falling through the lower parts 412 of the storage portions 410, fall-prevention units may be provided. The fall-prevention units may, for example, provide negative pressure to the storage portions 410. As illustrated in FIG. 1 and 3A, hole-shaped vacuum ports 430 are disposed on the walls of the storage portions 410 and the vacuum ports 430 are connected to a negative pressure providing unit 480. Accordingly, negative pressure is provided by the negative pressure providing unit 480 to the storage portions 410 through the vacuum ports 430 and thus, the cartridges 200 may be maintained in the storage portions 410.

The extraction unit 400 is moved forward by the actuator 490 as illustrated in FIG. 3C, and the outlets 302 of the guide rails 300 are blocked by the blocking portion 401 of the extraction unit 400. In addition, while the cartridges 200 are stored in the storage portions 410, the cartridges 200 are in an insertion position so as to be inserted into reactant chambers 70 of a reactor 100. The insertion position denotes a position that allows the blocking portion 401 to block the outlets 302 of the guide rails 300 and the storage portions 410 to face the reactant chambers 70 of the reactor 100. The insertion position may be the same as the blocking position, but the present embodiment is not limited thereto.

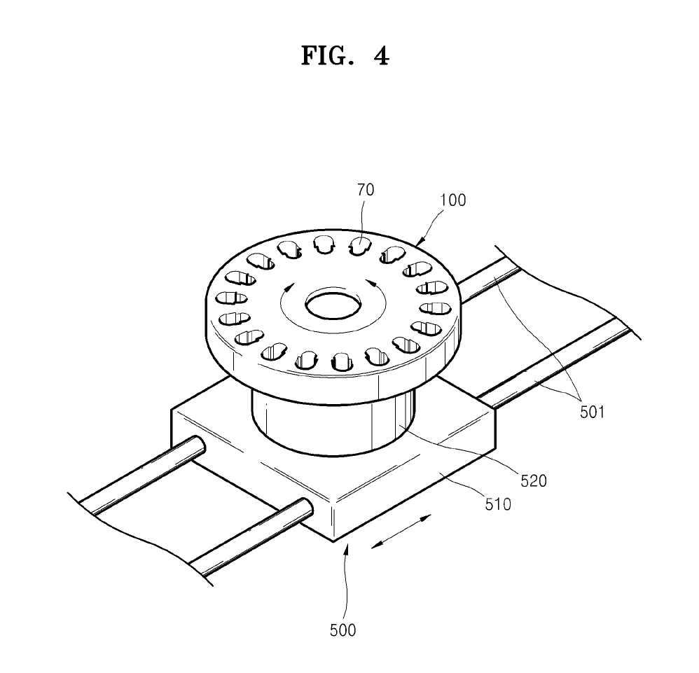

FIG. 4 is a perspective view of the transfer unit 500 illustrated in FIG. 1. Referring to FIG. 4, the transfer unit 500 may include a rotation portion 520 and a transfer portion 510. The rotation portion 520 is mounted on the transfer portion 510. The transfer portion 510 may be, for example, guided by a pair of guide bars 501 and moved in a straight line. The reactor 100 is mounted on the rotation portion 520 which rotates the reactor 100. Accordingly, a plurality of reactant chambers 70 may be disposed below the storage portions 410 storing the cartridge 200 holding the designated reagents.

Referring back to FIG. 1, the insertion unit 600 inserts the cartridges 200 stored in the storage portions 410 into the reactant chambers 70 of the reactor 100. The insertion unit 600 may include an insertion member, for example, a piston 610, for pushing the cartridges 200 stored in the storage portions 410. The insertion unit 600 may include actuating unit (not shown), such as a pneumatic actuator or an electric motor, for reciprocating the piston 610.

According to such a configuration, the cartridges 200 containing the solid-state reactants are inserted in the guide rails 300 through the inlets 301, and the cartridges 200 move to the outlets 302 through the rails 300. As illustrated in FIG. 3A, when the extraction unit 400 is positioned at the blocking position, the cartridges 200 are blocked by the blocking portion 401 and are maintained in the guide rail 300. When the extraction unit 400 moves to the extraction position as illustrated in FIG. 3B, the cartridges 200 fall into the storage portions 410 through the outlets 302 of the guide rails 300. Here, the negative pressure providing unit 480 provides the negative pressure to the storage portions 410 through the vacuum ports 430. Accordingly, the cartridges 200 are maintained in the storage portions 410 without falling through the opened lower parts 412 of the storage portions 410. The screen 420 may block the reagents accommodated in the cartridges 200 from being contaminated. In addition, the screen 420 may prevent the cartridges 200 from being separated from the storage portions 410 through the opened side parts 413 when the cartridges 200 fall into the storage portions 410 from the guide rails 300. The transfer unit 500 allows the reactant chambers 70 of the reactor 100 mounted on the transfer unit 500 to be disposed below the storage portions 410 by moving the reactor 100 using linear movement and rotational movement.

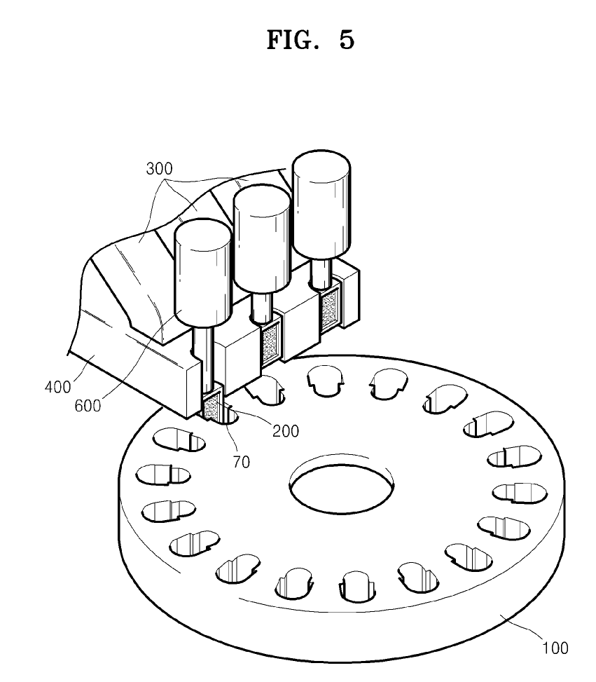

As illustrated in FIG. 5, the insertion units 600 drive the pistons 610 and push the cartridges 200 so as to insert them into the reactant chambers 70. When a plurality of guide rails 300 is provided in the loading apparatus, the cartridges 200 holding each different reactant may be respectively provided to the guide rails 300. Since the transfer unit 500 moves/rotates the reactor 100, the cartridge 200 provided through one of the guide rails 300 may be inserted into each of the reactant chambers 70.

According to the loading apparatus, the cartridges 200 holding the designated reactants may be inserted into the reactant chambers 70 of the reactor 100.

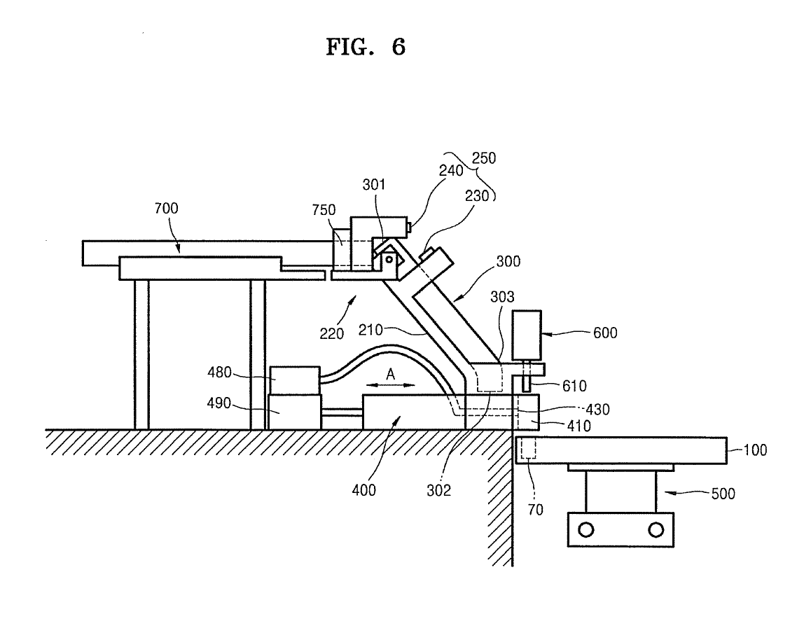

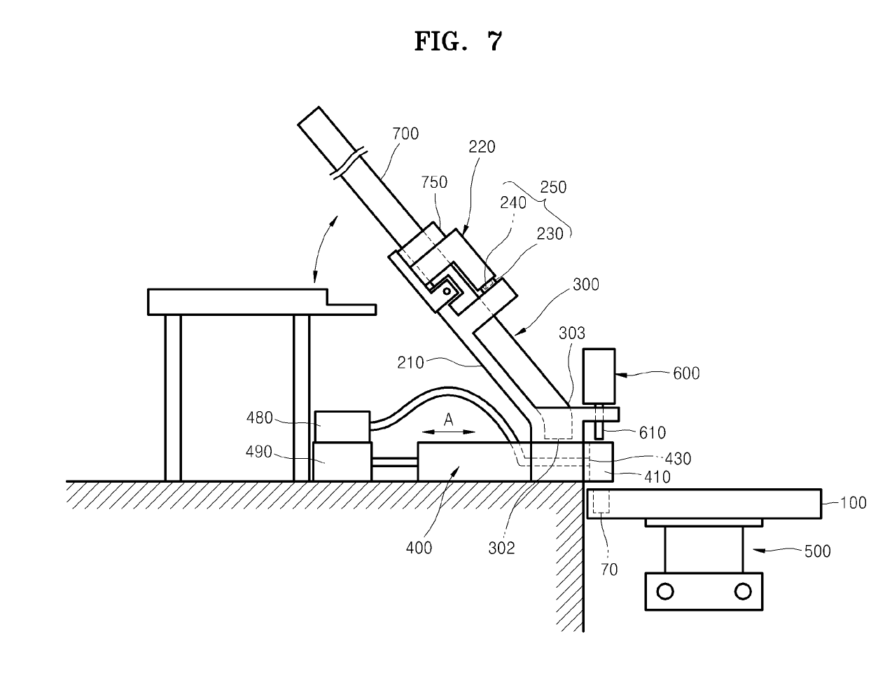

FIGS. 6 and 7 are side views schematically illustrating a loading apparatus according to another embodiment. The loading apparatus according to the present embodiment differs from the loading apparatus illustrated in FIGS. 1-5 in that a plurality of cartridges 200 are provided to the guide rail 300 by using a tray 700. Referring to FIGS. 6 and 7, an arrangement unit 220 is provided on a loading frame 210 on which the guide rail 300 is disposed. The arrangement unit 220 is attached to the loading frame 210 to be rotated. The tray 700 may be installed in the arrangement unit 220 in an installation position as illustrated in FIG. 6. As illustrated in FIG. 7, the arrangement unit 220 is rotated and thus the tray 700 may be aligned with the inlet 301 of the guide rail 300. In the present embodiment, a plurality of trays 700 are mounted on a holder 750 and then the holder 750 is installed in the arrangement unit 220.

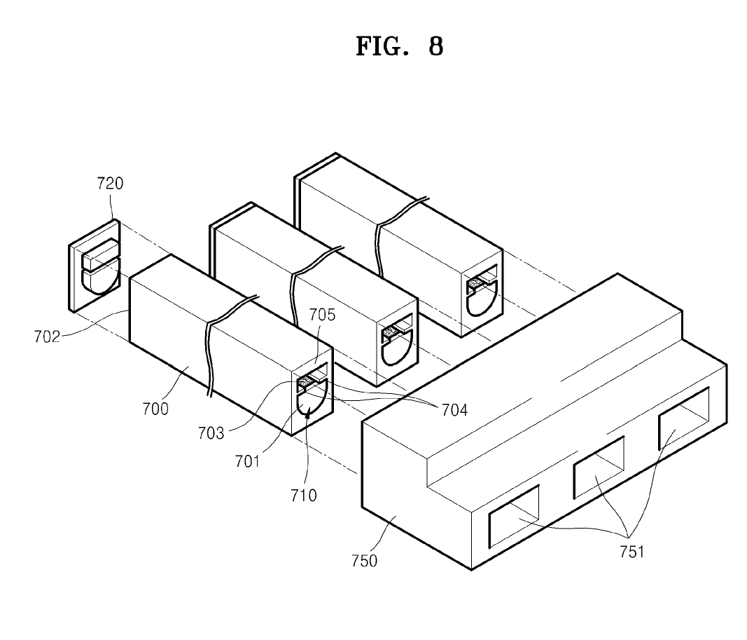

Referring to FIG. 8, a plurality of trays 700 are inserted in a plurality of mount units 751 provided in the holder 750. The trays 700 respectively include rails 710 extending in a longitudinal direction. The rails 710 have a tunnel-form and both end parts 701 and 702 of the rails 710 in a longitudinal direction are opened. However, upper parts 703 of the rails 710 are closed by the upper walls 705. The rails 710 include separation prevention projections 704 which prevent the cartridges 200 from being separated in an upper direction. Each tray 700 according to the present embodiment includes one rail 710 but is not limited thereto. When the guide rail 300 includes a plurality of rails 310, the trays 700 may also include a plurality of rails 710.

Both end parts 701 and 702 of the plurality of trays 700 may be blocked by stoppers 720 to prevent the cartridges 200 from being separated from the rails 710 through both end parts 701 and 702. The plurality of trays 700 may be fixed to the holder 750 while the stoppers 720 blocking the end parts 701 are removed. The holder 750, to which the trays 700 are fixed, is inserted into the arrangement unit 220, while the arrangement unit 220 is in the installation position, as illustrated in FIG. 6. The installation position denotes a position, in which the cartridges 200 in the tray 700 do not slide due to gravity so as to not be separated from the tray 700, when the tray 700 is installed to the arrangement unit 220. For example, the installation position may be the position where the tray 700 is horizontal. Here, the opened end part 701 of the tray 700 and the inlet 301 of the guide rail 300 are not arranged in a row. When the arrangement unit 220 is rotated and thus is positioned at the inclined position where the tray 700 has approximately the same inclination angle as the inclination angle of the guide rail 300, as illustrated in FIG. 7, the opened end part 701 of the tray 700 and the inlet 301 of the guide rail 300 are aligned with each other.

The loading apparatus may further include a maintaining unit 250 so as to maintain the arrangement unit 220 at the inclined position. The maintaining unit 250 may include, for example, a fixing portion 230 and a combining portion 240, wherein the fixing portion 230 is disposed on the loading frame 210 and the combining portion 240 is disposed on the arrangement unit 220. For example, a permanent magnet is attached on any one or both of the fixing portion 230 and the combining portion 240 and thus the arrangement unit 220 may be maintained in the installation position by a magnetic force. However, the maintaining unit 250 is not limited to the structure described above and may have, for example, a snap-fit structure, in which any one or both of the fixing portion 230 and the combining portion 240 are elastically changed and thus are combined with each other.

As described above, the tray 700 is installed in the arrangement unit 220 at the installation position so as to prevent the cartridge 200 from being separated from the tray 700 during an installation process.

In the above embodiments, the reactor 100 including the reactant chambers 70 is described. However, the reactor to which the cartridges holding the reactants are loaded using the loading apparatus according to the present embodiment is not limited thereto. The loading apparatus may be applied to any reactor, which may accommodate the cartridges 200 holding solid-state reactants.

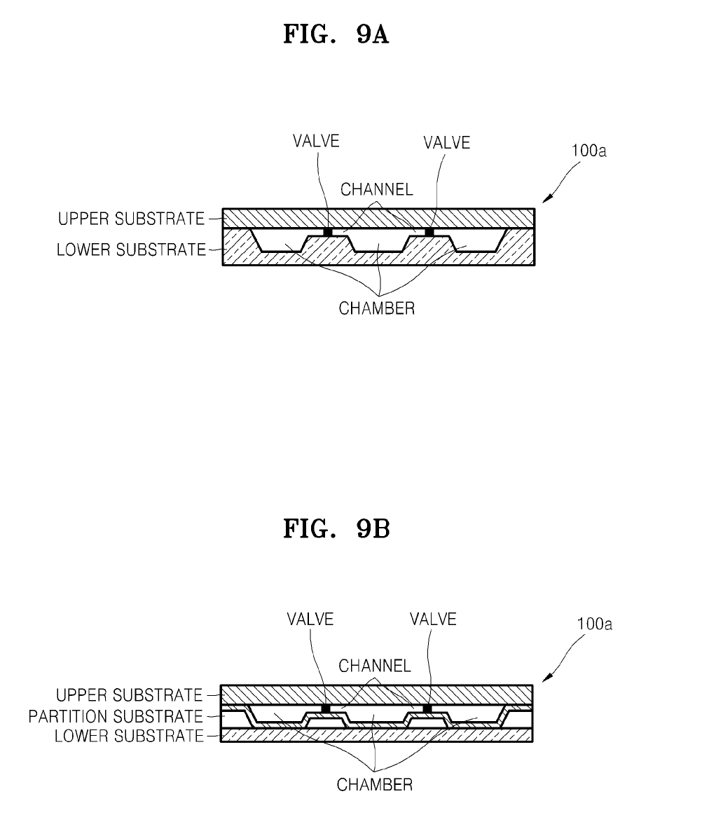

For example, the reactor may be a microfluidic device 100a used for a biochemical examination of biomaterials such as blood and urine, as described in FIGS. 9A and 9B. The microfluidic device 100a may be, for example, a disc-type which may be rotatable, and include chambers for holding fluids and microfluidic structures providing flow paths for the fluids to flow. The microfluidic device 100a may be rotated based on its rotation center. In the microfluidic structures, moving and mixing of samples are accomplished due to the centrifugal force generated by rotation of the microfluidic device 100a.

A reagent for performing a blood biochemical reaction may be used as a reactant. The reagent may be lyophilized while being accommodated in the cartridge 200. The lyophilization process may include freezing and drying, wherein the freezing changes moisture included in a liquid-state reagent to an ice-state and the drying removes the moisture of the frozen reagent. The drying process may use sublimation, in which frozen moisture is directly changed into vapor. However, the sublimation may not always be used in the whole drying process and may be used in some part of the drying process. For the sublimation, pressure of the drying process may be reduced to a triple point (6 mbar or 4.6 Torr) or below but a fixed pressure may not always be maintained. The temperature of the drying process may be changed and the temperature may be gradually increased after the freezing process. A lyophilization program may be appropriately set according to the type and amount of the reagent. Also, a plurality of cartridges 200 respectively holding liquid-state reagents are installed in the tray 700 and the tray 700 is put into a freeze-dryer, thereby lyophilizing the liquid-state reagents.

The microfluidic device 100a may be formed of a plastic material such as acryl and polydimethylsiloxane (PDMS) which can be easily molded and the surface thereof are biologically inactive. However, the present embodiment is not limited thereto and the microfluidic device 100a may be formed of a material having chemical and biological stability, optical transparency, and mechanical processibility. The microfluidic device 100a may be formed of various layers of substrates. Engraved structures corresponding to chambers or channels are formed on contacting surfaces of the substrates and the substrates are combined with each other, thereby providing the spaces and flow paths in the microfluidic device 100a. The substrates are attached to each other using a bonding agent or a double-sided adhesive tape, ultrasonic adhering, or laser welding.

One or more valves for controlling the flow through the channels may be provided in the channels. Various forms of microfluidic valves may be employed as the valve. A capillary valve, which passively opens at a fixed pressure, may be employed or a valve actively operated by receiving power or energy from the outside when an operation signal is transmitted/received, may be employed. The valve according to the present embodiment is a normally closed valve which closes the sample distribution channel to prevent the fluid from flowing before absorbing electromagnetic energy.

The closed valve may include a solid-state valve material at room temperature. The valve material exists in a solidified state and thus blocks the channel. The valve material is melted at a high temperature so as to be transferred to a space included in the channel and is solidified again while the channel is opened. Energy irradiated from the outside may be, for example, an electromagnetic wave, and an energy source may be a laser light source irradiating a laser beam, a light emitting diode irradiating a visible ray or infrared rays, or a xenon lamp. In the case of the laser light source, at least one laser diode may be included. The valve material may be a thermoplastic resin or a phase-change material, which is in a solid-state at room temperature. The phase-change material may be wax, gel, or a thermoplastic resin. In the valve material, a plurality of fine heating particles generating heat by absorbing electromagnetic energy may be dispersed. When electromagnetic energy is supplied by, for example, a laser light, the temperature of the fine heating particles is rapidly increased so as to generate heat and the fine heating particles are uniformly dispersed in the valve material. Thus, the fine heating particles may have a core including a metal element, and a hydrophobic surface. The fine heating particles may be stored while being dispersed in carrier oil. In order to uniformly disperse the fine heating particles having a hydrophobic surface, the carrier oil may be hydrophobic.

Since it is difficult to store the reagents in a liquid state, the liquid state reagents are loaded into the cartridge 200 as illustrated in FIG. 2 and are lyophilized. Then, the cartridge 200 is installed in the microfluidic device 100a. Here, when the microfluidic device 100a has a double-substrate structure as illustrated in FIG. 9A, the cartridge 200 is installed to chambers defined by a lower substrate using the loading apparatus illustrated in FIGS. 1-8 and then an upper substrate is attached to the lower substrate. When the microfluidic device 100a has a triple-substrate structure as illustrated in FIG. 9B, the cartridge 200 is installed in chambers defined by the lower substrate and a partition substrate using the loading apparatuses illustrated in FIGS. 1-8 and then the upper substrate may be combined with the partition substrate.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. An apparatus for loading cartridges containing reactants into chambers of a reactor, the apparatus comprising:
at least one guide rail which transfers a cartridge;
an extraction unit comprising at least one storage portion and a blocking portion, the extraction unit moving between a first position in which the blocking portion blocks an outlet of the guide rail and a second position in which the cartridge is output through the outlet of the guide rail and stored by the storage portion;
a transfer unit which moves the reactor so that a chamber of the reactor is aligned with the storage portion; and
an insertion unit which moves the cartridge from the storage portion into the chamber of the reactor.

2. The apparatus of claim 1, wherein the guide rail comprises an inclined section including an inlet through which the cartridge is input and a vertical section including the outlet through which the cartridge is transferred to the storage portion of the extraction unit.

3. The apparatus of claim 2, wherein the storage portion is disposed below the outlet of the guide rail in the second position.

4. The apparatus of claim 3, wherein the transfer unit moves the chambers of the reactor to be disposed below the storage portion.

5. The apparatus of claim 4, wherein the storage portion comprises an upper part, a lower part, and one side that are opened.

6. The apparatus of claim 5, further comprising a screen which blocks the opened one side of the storage portion.

7. The apparatus of claim 5, further comprising a fall-prevention unit which prevents the cartridges stored in the storage portion from falling out of the storage portion.

8. The apparatus of claim 7, wherein the fall-prevention unit comprises a negative pressure providing unit which provides negative pressure to the storage portion to hold the cartridge in the storage portion.

9. The apparatus of claim 1, wherein the reactant is a solid-state reactant.

10. The apparatus of claim 1, wherein the reactant is a lyophilized reactant.

11. The apparatus of claim 1, further comprising:
a tray including at least one tunnel-shaped rail of which end parts in a longitudinal direction are open so that the cartridges are capable of being installed therein;
a holder on which the tray is mounted; and
an arrangement unit, on which the holder is installed, arranging the end parts of the tray and the guide rail in a row so that the cartridges can be moved to the guide rail from the tray.

12. The apparatus of claim 11, wherein the arrangement unit is movable between a first position, in which the holder is installed, and a second position, in which the rail of the tray is aligned with the guide rail.

13. The apparatus of claim 12, further comprising a maintaining unit which maintains the arrangement unit in the second position.

14. The apparatus of claim 13, wherein the maintaining unit maintains the arrangement unit in the second position by using a magnetic force.

15. The apparatus of claim 1, wherein the transfer unit comprises a transfer portion which mounted on at least one guide bar and moves the reactor in straight line, and a rotation portion which is mounted on the transfer portion and rotates the reactor.

16. A method of loading reactants, the method comprising:
supplying a cartridge containing a reactant to a guide rail that is inclined in a downward direction;
moving an extraction unit from a first position, in which an outlet of the guide rail is blocked, to a second position, in which the cartridge is output through the outlet of the guide rail and stored in a storage portion of the extraction unit;
moving the reactor so that a reactant chamber of the reactor is aligned with the storage portion;
transferring the cartridge from the storage portion into the reactant chamber.

17. The method of claim 16, wherein during the storing the cartridge in the storage portion, the cartridge is held in the storage portion by providing negative pressure in the storage portion.

18. The method of claim 16, wherein the supplying of the cartridge to the guide rail comprises:
storing the cartridge in a tray having a tunnel form, in which end parts of the tray in a longitudinal direction are open; and
aligning an outlet of the tray and an inlet of the guide rail.

19. The method of claim 18, wherein the aligning the outlet of the tray and the inlet of the guide rail comprises:
mounting the tray on a holder;
installing the holder in the arrangement unit positioned at a first position;
moving the arrangement unit to a second position so that the outlet of the tray is aligned with the inlet of the guide rail.

20. The method of claim 19, wherein in the first position, the tray is positioned at an angle in which the cartridge in the tray does not slide out of the tray due to gravity.

21. The method of claim 16, wherein the reactant is a solid-state reactant.

22. The method of claim 16, wherein the reactant is a lyophilized reactant.

23. The method of claim 16, wherein the moving the reactor comprises at least one of moving a transfer unit on which the reactor is mounted in a straight line and rotating the transfer unit.
